(19) United States
(12) Patent Application Publication
(10) Pub. No.: US 2005/0116056 A1
(43) Pub. Date: Jun. 2, 2005

(54) Fuel injector and method for installing a fuel injector in a valve seat

(76) Inventors: Waldemar Hans, Bamberg (DE); Helmut Hennemann, Schesslitz (DE); Christof Vogel, Bischberg (DE)

Correspondence Address: KENYON & KENYON, ONE BROADWAY, NEW YORK, NY, 10004, US

(21) Appl. No.: 10/450,961

(22) PCT Filed: Jul. 12, 2002
(86) PCT No.: PCT/DE02/02551

(51) Int. Cl. F02M 59/00; F02D 1/06

(52) U.S. Cl. 239/5; 239/533.2; 29/890.124

(57) ABSTRACT

A fuel injector, which, at its inflow-side end, has an intake connector at whose outer circumference at least two sealing rings are provided, which seal the fuel injector from a valve seat. Due to an intermediate ring, the two sealing rings are axially set apart from one another in a respective ring chamber. The intermediate ring is embodied independently of the intake connector and is made up of two parts. A flexible outer ring is locked in place on an inner extruded support ring, the outer ring only being mounted once the first sealing ring has already been moved across the support ring and has been stripped off. The fuel injector is particularly suited for the use in mixture-compressing internal combustion engines having external ignition.

### FIELD OF THE INVENTION

The present invention relates to a fuel injector, and a method for installing a fuel injector in a valve seat.

### BACKGROUND INFORMATION

At the outer periphery of various fuel injectors, a plurality of sealing elements in the form of sealing rings may be arranged in succession so as to ensure an effective sealing of the fuel injector from a valve seat.

For instance, German Patent Application No. 28 27 789 refers to providing two sealing rings at a stepped inflow connector of the fuel injector. These may be embodied as whole ring stacks, which then include a stuffing-box ring, an o-ring, an asbestos ring cord, and a plastic fusion ring arranged in immediate succession. German Patent Application No. 28 27 878 refers to fuel injectors whose sealing is accomplished via sealing stacks, additional rings, having so-called emergency-sealing properties, being provided in addition to the actual sealing rings in o-form. Furthermore, German Patent Application No. 28 27 850 refers to spacing two sealing rings at the periphery of the fuel injector by using a shoulder that radially projects beyond the outer circumference of the inflow-connecting piece.

Furthermore, a sealing system on a fuel injector is referred to in German Patent Application No. 37 03 615, in which two sealing rings in each case surround one of two connecting pieces independently from one another and appropriately seal it from a fuel-supply line.

Moreover, German Patent Application No. 197 35 665 refers to a fuel-injection system in which a fuel injector is connected via an intermediate piece to a valve-seat connector of a fuel-supply line and sealed therefrom. In this arrangement, both the inflow connector of the fuel injector and also the intermediate pieces each have a sealing ring at the outer circumference, which spatially are thus clearly located at a distance from one another.

### SUMMARY OF THE INVENTION

The exemplary fuel injector according to the present invention provides a sealing system having two sealing rings at its outer periphery, which may be especially easy to install, avoid excessive expansion and excessive spread of the sealing rings and may therefore basically avoid damage of the sealing rings. Nevertheless, it may guarantee sufficiently large support shoulders for the sealing rings and completely prevent the release of hydrocarbons into the environment, in compliance with ever stricter environmental demands.

Of particular advantage may be the simple handling of the two partial components of the intermediate ring. While the inner support ring may be installed in a very simple manner in a groove on the intake connector of the fuel injector by way of an inwardly projecting lip, the outer ring may be snapped into place on the support ring in an uncomplicated and reliable manner.

The locking bead on the support ring used for locking is arranged such that the high compression forces of the one sealing ring during the installation of the fuel injector in the receiving socket are absorbed by an upper horizontal locking surface. The lower axial demounting forces of the other sealing ring are sufficiently absorbed by a lower locking surface of the locking bead, which has a slanted configuration.

The exemplary method according to the present invention for installing a fuel injector in a valve seat may have the advantage that the overall installation may be performed in a fully automatic manner. In an especially advantageous manner, the sealing rings are handled very gently during the mounting, so that damage to the sealing rings is excluded. It may be especially advantageous that the sealing rings, despite being inserted in separate ring chambers, are barely spread open, so that there is no need to stretch them to a dangerous extent. Because the intermediate ring is arranged or configured in two parts, it is ensured that the first sealing ring is able to be installed without being overstretched, yet sufficiently large support shoulders are subsequently available for both sealing rings.

### BRIEF DESCRIPTION OF THE DRAWINGS

FIG. 1 shows an inflow-side end of a fuel injector having a sealing system configured according to the present invention for sealing the fuel injector from a valve seat.

FIG. 2 shows an enlargement of the cut-out section II in FIG. 1.

### DETAILED DESCRIPTION

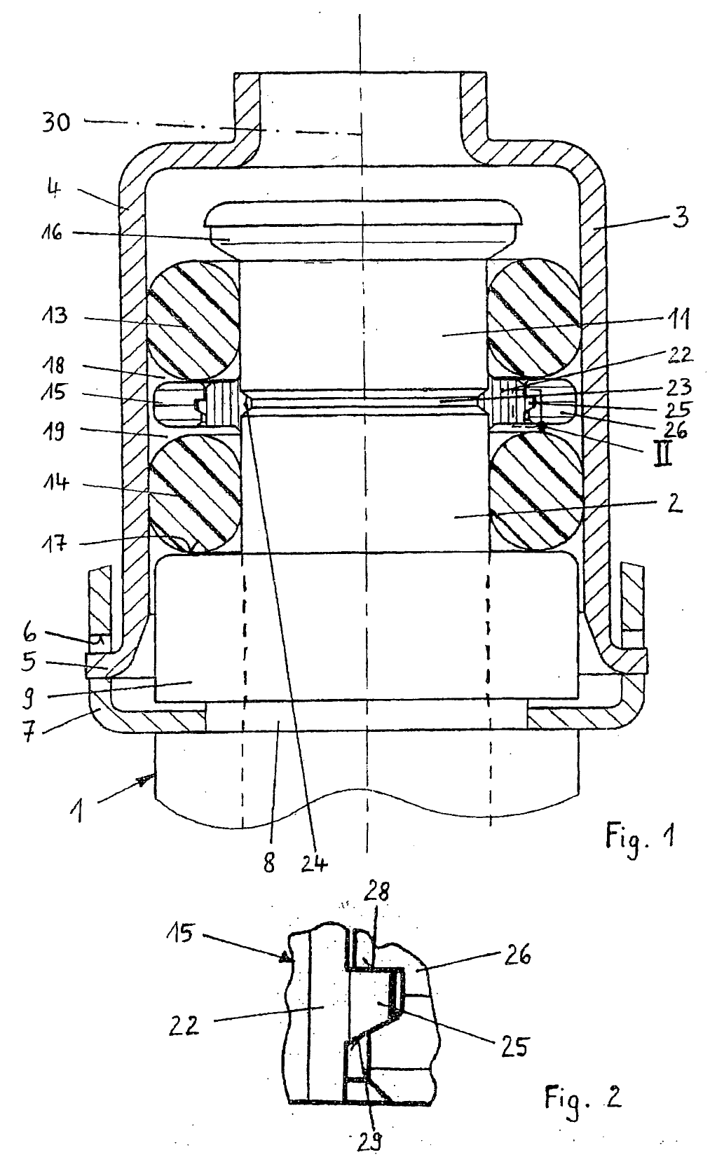

FIG. 1 shows a partial representation of a fuel injector 1, which, for instance, is embodied as a fuel injector for the direct injection of fuel into the combustion chamber of a mixture-compressing internal combustion engine having external ignition. By way of an inflow-side end 2, fuel injector 1 projects into a corresponding valve seat 3.

Valve seat 3 is embodied, for instance, as a cup-shaped intake connecting piece 4, which constitutes part of a fuel-supply line (not shown further), such as a fuel rail. The fuel-supply line usually has a plurality of intake connecting pieces 4, so that the fuel conveyed via the fuel-supply line may be distributed to a plurality of fuel injectors 1. Intake connecting piece 4 has a stepped arrangement or configuration, for example, and, at its end facing away from the fuel-supply line, has one or a plurality of affixation elements 5 projecting in the manner of a lip. These affixation elements 5 engage in openings 6 of an securing clamp 7, which is used to reliably secure fuel injector 1 in valve seat 3. Securing clamp 7 is inserted, for instance, in a circumferential groove 8 at the outer periphery of a plastic extrusion coat 9 of fuel injector 1.

Fuel injector 1 is largely surrounded by plastic extrusion coat 9, for example. However, at inflow-side end 2 of fuel injector 1, a metal intake connector 11 for the supply of fuel to the interior of fuel injector 1 projects beyond plastic extrusion coat 9. Above plastic extrusion coat 9, two sealing rings 13, 14, configured as O-rings, are situated at the outer periphery of intake connector 11. Due to an intermediate ring 15 configured according to the exemplary embodiment of the present invention, the two sealing rings 13, 14, which follow each other closely in the axial direction, are positioned at a spatial distance from one another. Forming the upstream end of fuel injector 1 is an upper retaining ring 16, which is made of plastic and mounted on intake connector 11. In this manner, both sealing rings 13, 14 are embedded between retaining ring 16 and upper end face 17 of plastic extrusion coat 9, intermediate ring 15 forming two ring chambers 18, 19 for sealing rings 13, 14.

In contrast to the sealing rings having so-called emergency-sealing properties known in part from the related art, the two sealing rings 13, 14 are two “full-fledged” sealing rings made of known elastomer sealing material. The necessity of two sealing rings immediately following one another at the periphery of fuel injector 1 results from the composition of certain fuels. In long-term use of sealing rings it has become apparent that hydrocarbons permeate through the elastomers normally used for sealing rings and may even permeate them completely. In order to fully prevent the emission of hydrocarbons into the environment in accordance with ever stricter environmental regulations, it may be advantageous to situate an additional sealing ring immediately behind a first sealing ring. In this manner, the second sealing ring following a sealing ring permeated in the manner described above, offers a substantially improved sealing reliability.

Intermediate ring 15, which partitions the sealing chamber into two ring chambers 18, 19, is made up of two sub-components. An inner support ring 22 engages, for instance, in a circumferential groove 23 at the periphery of intake connector 11. Ideally, support ring 22 is extruded (injected) on the metal valve body, together with plastic extrusion coat 9 and retaining ring 16, in one plastic-extrusion procedure. On its inner side, support ring 22 has a slanted lip 24, which projects toward the inside and is able to be inserted in groove 23 with form accuracy.

Provided at the outer diameter of support ring 22 is a locking bead 25, which projects radially outward and at which an outer ring 26, which also belongs to intermediate ring 15, is able to be snapped into place.

The region of locking bead 25 is shown in FIG. 2 in an enlarged view. Locking bead 25 at support ring 22 is arranged or configured such that the high compression forces of second sealing ring 13 during the installation of fuel injector 1 in intake connecting piece 4 are absorbed by an upper locking surface 28, which mostly extends perpendicularly to a longitudinal valve axis 30. The lower axial demounting forces of first sealing ring 14 are sufficiently absorbed by a lower locking surface 29 of locking bead 25, locking surface 29 having a slanted arrangement or configuration. Outer ring 26 is made of flexible plastic. When outer ring 26 is mounted on inner support ring 22, this plastic expands and then locks into place in the limit position above locking bead 25. Intermediate ring 15, made up of outer ring 26 and support ring 22, is used as support shoulder for second sealing ring 13.

The mounting of the sealing system on intake connector 11 of fuel injector 1 is briefly explained in the following. As already described above, plastic extrusion coat 9, inner support ring 22 of intermediate ring 15, and retaining ring 16 are, for instance, simultaneously extruded on the metal valve body in one extrusion procedure. Subsequently, first sealing ring 14 is spread open, mounted on intake connector 11, moved across support ring 22 and stripped into ring chamber 19. Then, outer ring 26 is clipped onto inner support ring 22 to complete intermediate ring 15. Second sealing ring 13 is then spread open, mounted on intake connector 11 and stripped into ring chamber 18. With the aid of the sealing system mounted in this manner on intake connector 11, fuel injector 1 may be inserted in valve seat 3.

The exemplary embodiment and/or method of the present invention is not limited to the described exemplary embodiment or method. Thus, intake connector 11, for instance, may have a stepped arrangement or configuration in the region of sealing rings 13, 14 and/or sealing rings 13, 14 may have different cross sections or diameters.

1-13. (canceled)

14. A fuel injector for injecting fuel into a combustion chamber of a mixture-compressing internal combustion engine having external ignition, the fuel injector having a longitudinal valve axis, the fuel injector comprising:
an intake connector situated at an inflow-side end, and having at least two sealing rings provided at an outer periphery of the intake connector to seal the fuel injector from a valve seat; and
an intermediate ring, wherein, via the intermediate ring, the two sealing rings are axially set apart from one another, being situated in each case in a ring chamber, the intermediate ring being embodied independently of the intake connector and including two parts.

15. The fuel injector of claim 14, wherein the intermediate ring includes an inner support ring and an outer ring.

16. The fuel injector of claim 15, wherein the inner support ring, via an inwardly projecting lip, engages in a groove of the intake connector.

17. The fuel injector of claim 15, wherein the inner support ring is made of plastic.

18. The fuel injector of claim 17, wherein the inner support ring is made of the same plastic as a plastic extrusion coat partially surrounding the fuel injector.

19. The fuel injector of claim 14, further comprising: an outwardly projecting locking bead, at an outer diameter of the support ring, at which the outer ring is able to lock into place.

20. The fuel injector of claim 19, wherein an upper locking surface of the locking bead extends largely perpendicularly to the longitudinal valve axis and a lower locking surface has a slanted arrangement.

21. The fuel injector of claim 15, wherein the outer ring is made of flexible plastic.

22. The fuel injector of claim 14, wherein the intermediate ring forms a support shoulder for at least one of the at least two sealing rings.

23. A method for installing a fuel injector in a valve seat, the fuel injector, at the inflow-side end, having an intake connector at whose outer circumference at least two sealing rings are provided, which are axially set apart from one another by an intermediate ring and which seal the fuel injector from the valve seat, the method comprising:
affixing an inner support ring of the intermediate ring on a circumference of the intake connector;
spreading open a first one of the at least two sealing rings, mounting it on the intake connector, moving it across the inner support ring and stripping it into a ring chamber, and mounting an outer ring on the inner support ring to complete the intermediate ring;
spreading open a second sealing ring, mounting it on the intake connector and stripping it into an additional ring chamber; and
subsequently inserting the fuel injector in the valve seat together with a sealing system thus mounted on the intake connector.

24. The method of claim 23, wherein the inner support ring of the intermediate ring is extruded on a circumference of the intake connector in a same extrusion procedure as a plastic extrusion coat at least partially surrounding the fuel injector.

25. The method of claim 23, wherein the outer ring of the intermediate ring is locked into place on a locking bead of the inner support ring.

26. The method of claim 23, wherein the fuel injector is secured after having been inserted in the valve seat with corresponding affixation elements provided on the valve seat and on the fuel injector.
